(19) United States
(12) Patent Application Publication
(10) Pub. No.: US 2015/0109192 A1
(43) Pub. Date: Apr. 23, 2015

(54) IMAGE SENSING SYSTEM, IMAGE SENSING METHOD, EYE TRACKING SYSTEM, EYE TRACKING METHOD

(71) Applicant: PixArt Imaging Inc., Hsin-Chu City (TW)

(72) Inventor: Yu-Hao Huang, Hsin-Chu City (TW)

(73) Assignee: PixArt Imaging Inc., Hsin-Chu City (TW)

(21) Appl. No.: 14/283,235

(22) Filed: May 21, 2014

(30) Foreign Application Priority Data
Oct. 18, 2013 (TW) 102137768

(51) Int. Cl. G06F 3/01

(52) U.S. Cl. CPC G06F 3/013
USPC 345/156

(57) ABSTRACT

An image sensing system comprising: a controller; and an image sensing module. If the image sensing module performs a low resolution image sensing and the controller senses a trigger operation, the controller controls the image sensing module to switch from the low resolution image sensing to a high resolution image sensing.

### BACKGROUND OF THE INVENTION

1. Field of the Invention

The present invention relates to an image sensing system/method and an eye tracking system/method, and particularly relates to an image sensing system/method and an eye tracking system/method that can perform an image sensing for different resolutions.

2. Description of the Prior Art

A user can utilize eye sight to control an electronic apparatus via a conventional eye tracking apparatus. FIG. 1 is a schematic diagram illustrating a prior art eye tracking apparatus 100. As shown in FIG. 1, the user U can move a cursor Vr on a display D for the eye tracking apparatus via the eye sight of the user. The eye tracking apparatus 100 comprises an image sensing module 101 which senses the eye sight of the user to determine the eye sight location. How to determine eye sight location of the user via an image is known by persons skilled in the art, thus it is omitted for brevity here.

However, the user may not utilize eye sight to control the eye tracking apparatus 100, even if he stands in front of the eye tracking apparatus 100. For example, the user just stands in front of the eye tracking apparatus 100 to watch other stuffs, or watches other concepts on the display D. Or, the image sensing module 101 only senses the image in order to compute intensity of the environment light. However, the image sensing module 101 in the prior art eye tracking apparatus 100 only senses the image via a constant resolution (i.e. the pixel amount for sensing the image). If the resolution is too low, it is hard to determine the user's eye sight. On the contrary, if the resolution is too high, more power is consumed and the data computing dramatically increases.

### SUMMARY OF THE INVENTION

Therefore, one objective of the present invention is to provide an image sensing system and an image sensing method, which can perform image sensing for different resolutions.

Another objective of the present invention is to provide an eye tracking system and an eye tracking method, which can perform image sensing for different resolutions.

One embodiment of the present invention discloses an image sensing system, which comprises: a controller; and an image sensing module. If the image sensing module performs a low resolution image sensing and the controller senses a trigger operation, the controller controls the image sensing module to switch from the low resolution image sensing to a high resolution image sensing.

Another embodiment of the present invention discloses an eye tracking system, which comprises: a display; a controller; and an image sensing module. The controller controls the image sensing module to perform a low resolution image sensing to determine if a user watches the display. The controller controls the image sensing module switches from the low resolution image sensing to a high resolution image sensing to track the user's eye sight if the image sensing module performs the low resolution image sensing and the controller senses a trigger operation.

The image sensing method and the eye tracking method can be acquired in view of embodiments, thus it is omitted for brevity here.

In view of above-mentioned embodiments, the present invention can perform the low resolution image sensing or the high resolution image sensing corresponding to different functions. By this way, the issue due to performing a constant resolution image sensing can be avoided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a prior art eye tracking apparatus.

FIG. 2, FIG. 3 are block diagrams illustrating an eye tracking apparatus according to one embodiment of the present invention.

FIG. 4 is a block diagram illustrating an eye tracking apparatus according to another embodiment of the present invention.

FIG. 5, FIG. 6 and FIG. 7 are schematic diagrams illustrating the examples for how the image sensing module performs a low resolution image sensing and a high resolution image sensing.

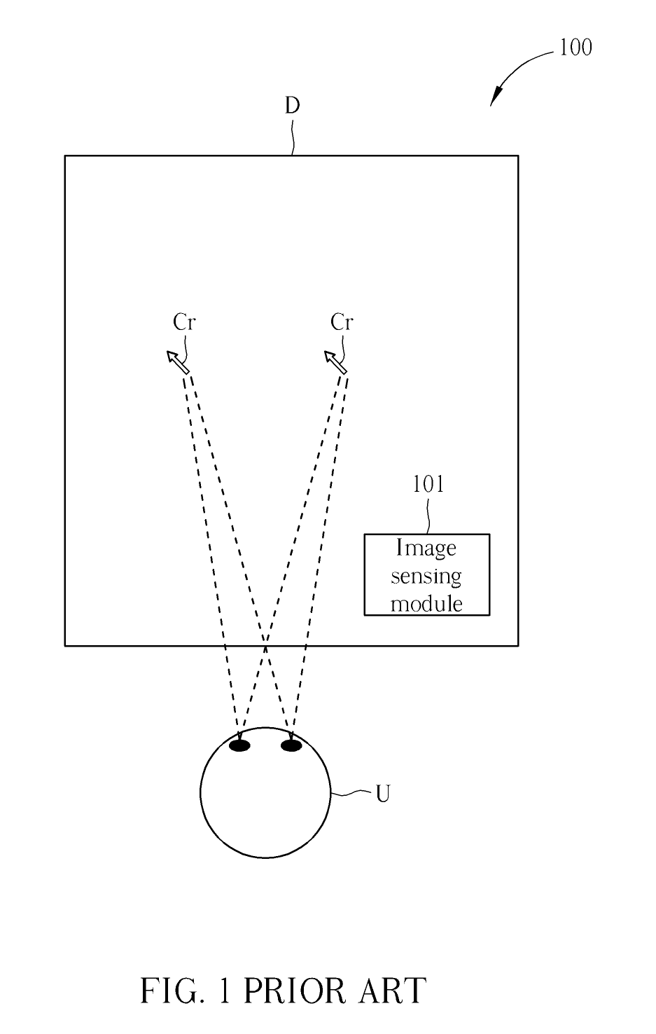

### DETAILED DESCRIPTION

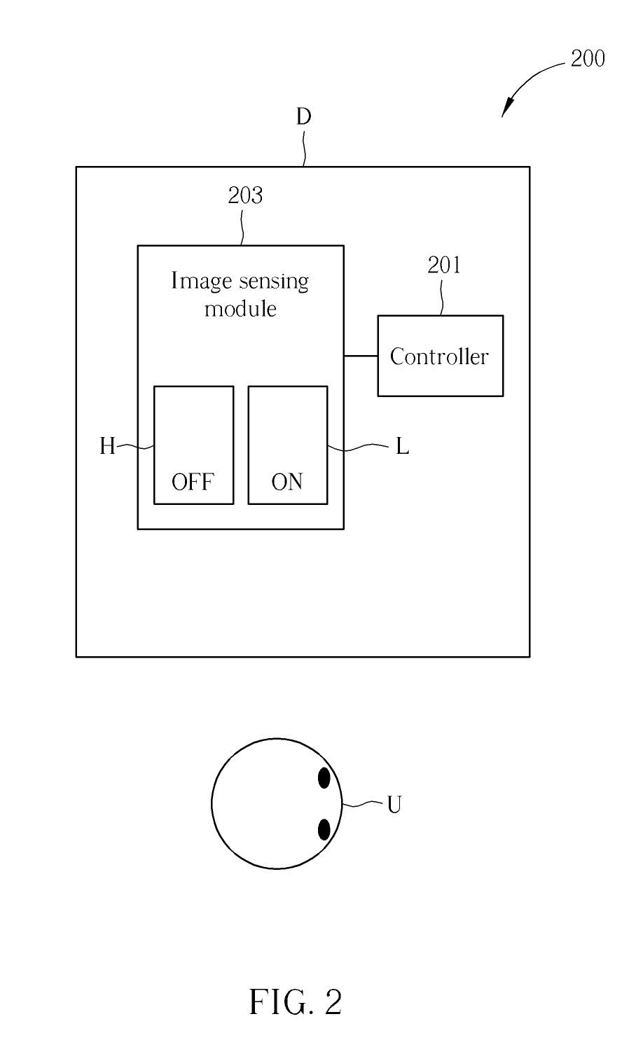

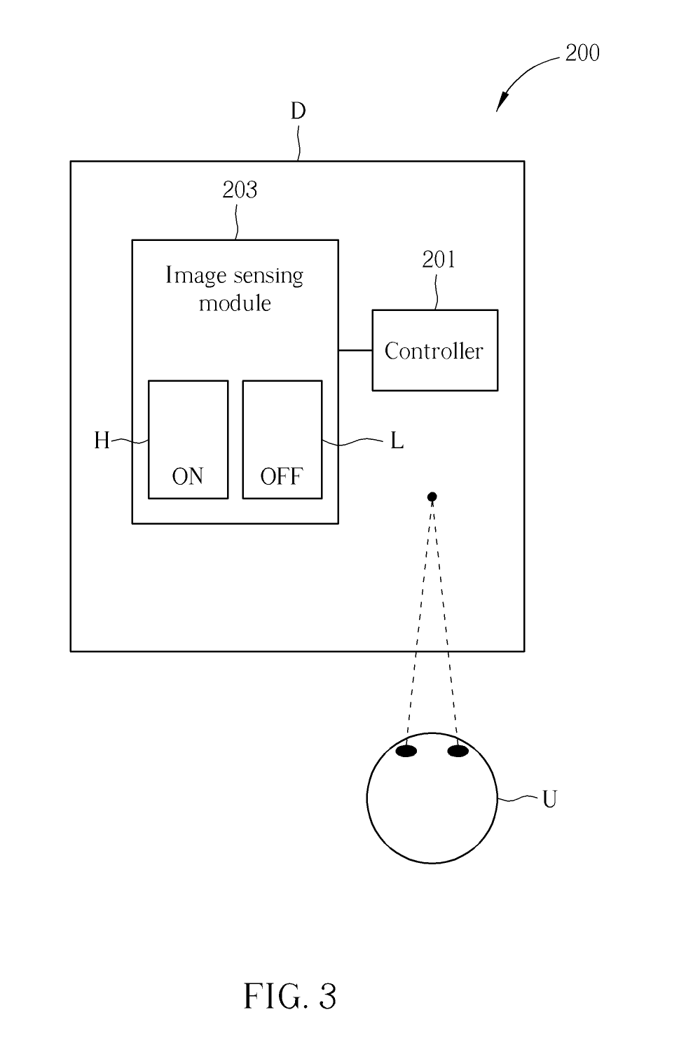

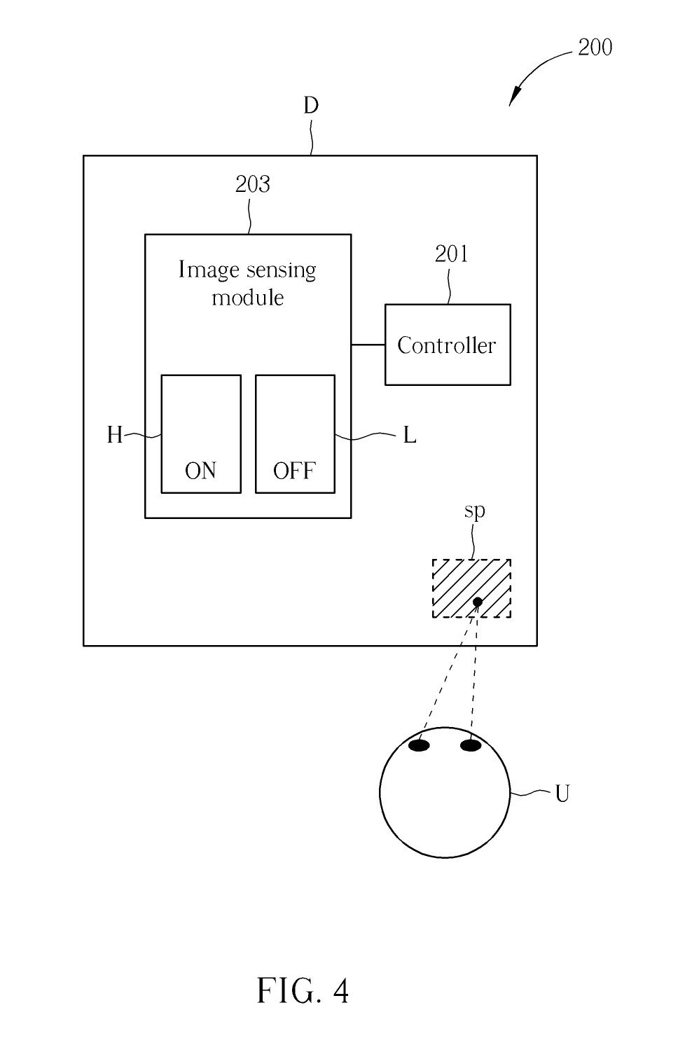

FIG. 2, FIG. 3 are block diagrams illustrating an eye tracking apparatus according to one embodiment of the present invention. As shown in FIG. 2, the eye tracking system 200 comprises a display D, a controller 201 and an image sensing module 203. The image sensing module 203 comprises a high resolution image sensor H and a low resolution image sensor L. The controller 201 controls the image sensing module 203 to perform a low resolution image sensing to determine if the user U watches the display D (i.e. turn on the low resolution image sensor L and turn off the high resolution image sensor H) . If the image sensing module 203 performs a low resolution image sensing and the controller 201 senses a trigger operation, the controller 201 controls the image sensing module 203 to switch from the low resolution image sensing to the high resolution image sensing, to track the eye sight of the user U (i.e. turn off the low resolution image sensor L and turn on the high resolution image sensor H).

For example, if the user U does not watch the display D in FIG. 2, the image sensing module 203 performs a low resolution image sensing to determine if the user D watches the display D or not. In FIG. 3, the user U performs a trigger operation, thus the image sensing module 203 performs the high resolution image sensing to track the eye sight of the user U. Thereby less power and less data computing amount are needed to determine if the user U is watching the display D, and then the high resolution image sensing is performed to determine the eye sight more accurately. Besides referring the resolution, as above mentioned, it can further refer to light sensitivity to acquire a better balance for the image quality and power consumption. For example, the image for high resolution image sensor H may already have enough quality due to high resolution, thus a low light sensitivity can be applied, to save power. On the opposite, a high light sensitivity can be applied to keep the image quality when the low resolution image sensor L is utilized, due to the low resolution for the low resolution image sensor L. Above-mentioned examples do not mean to limit the scope of the present invention. Different combinations for resolutions and light sensitivities can be applied to the present invention, of course.

Various operations can be applied as trigger operations. For example, as shown in FIG. 3, if the eye sight of the user U stop at a specific point on the display D for at least one predetermined period of time, the eye sight tracking function is activated. Alternatively, the user U can perform a specific gesture to trigger. Or, the user can use a hardware switch or a software switch (ex. an icon displayed on the display D) to trigger. The trigger operation can be the combination for above-mentioned operations. For example, the image tracking is activated if the eye sight of the user U stop at a specific point on the display D for at least one predetermined period of time and the user triggers a switch. However, please note the trigger operation is not limited to above-mentioned operations.

The above-mentioned low resolution image sensing is not limited to sense if the user's eye sight locates on the display or not, but also can be applied to other functions. For example, if the controller 201 controls the image sensing module 203 to sense environment light and to determine the intensity of the environment light, the image sensing module 203 senses the environment light via low resolution. In one embodiment, the controller 201 controls the image sensing module to sense environment light via the low resolution image sensing before the controller 201 controls the image sensing module 203 switches from the low resolution to the high resolution. By this way, the parameter for pre-sensed environment can be applied to sense an image before switching to the high resolution image sensing.

The high resolution image sensing is not necessary to be performed and computed again, thus the converging time (ex. the time before the eye tracking system becomes stable) can be reduced.

Alternatively, the controller 201 controls the image sensing module 203 to perform a low resolution image sensing, to determine if the user U performs a putting on operation for an accessory apparatus. The accessory apparatus can be a stuff that may affect eye sight determination such as a glass or a hat, or an apparatus that can assist the controller 201 to track the eye sight of the user U, such as a glass with tiny cameras. The eye tracking apparatus 200 must have different computing methods corresponding to different situations, thus the operation for determining if the user U performs a putting on operation for an accessory apparatus can help the determining for the user's eye sight.

In the embodiment of FIG. 3, no matter the eye tracking system 200 enters the eye sight tracking mode or not, the controller 201 controls the image sensing module 203 to perform the high resolution image sensing to perform the iris identifying or the user authenticating if the eye tracking system 200 is commanded to perform a iris identifying or a user authenticating. In the embodiment of FIG. 3, if the user U is informed by the eye tracking system 200 to perform iris identifying or the user authenticating, or the user U desires to perform the iris identifying or the user authenticating without being informed, the user can gaze at a specific region SP on the display D, and then the image sensing module 203 senses the image in this region via high resolution to perform the iris identifying or the user authenticating. However, it does not mean the iris identifying or the user authenticating are limited to be performed by these methods.

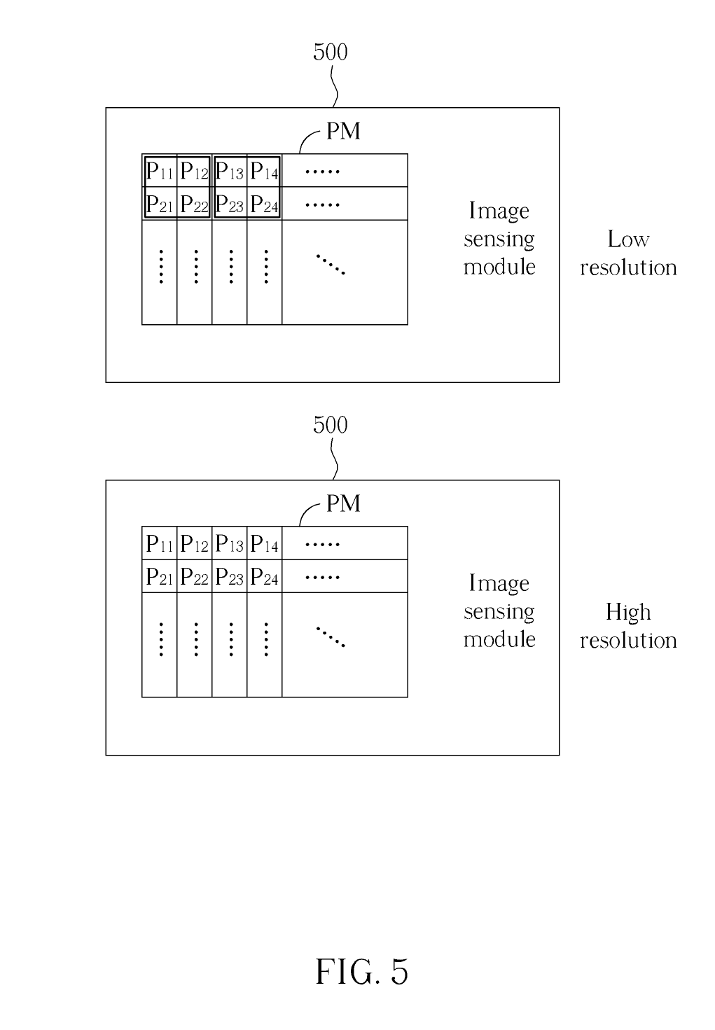

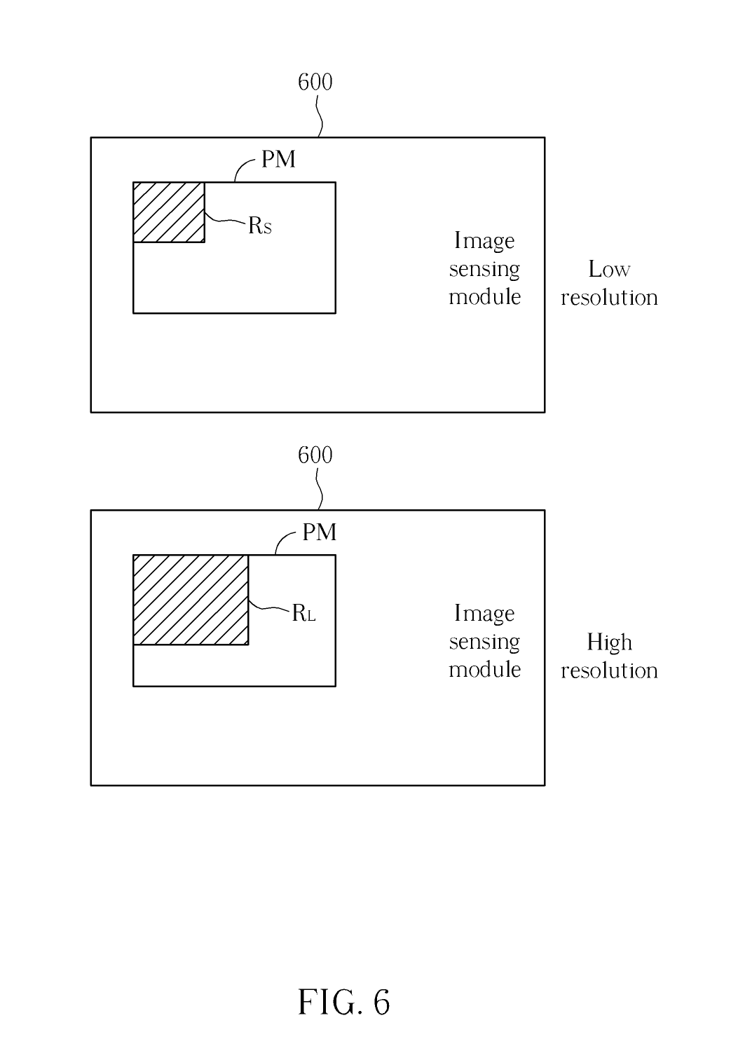

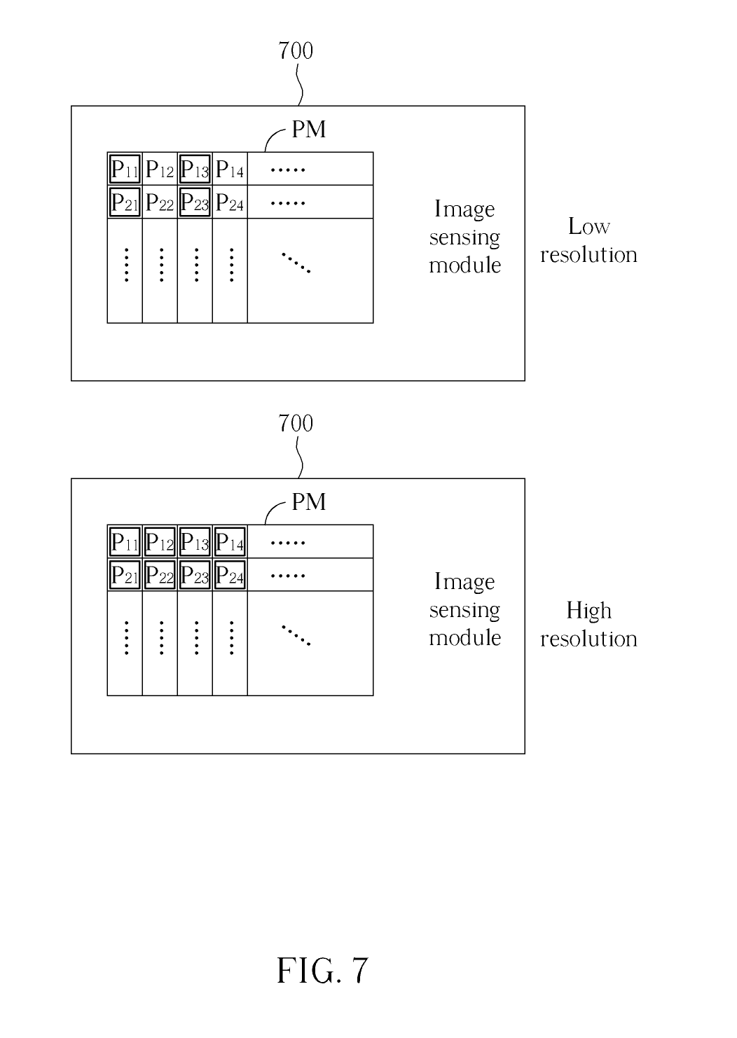

In above-mentioned embodiments, the image sensing module 203 uses two independent image sensors to perform the low resolution image sensing and the high resolution image sensing. However, the image sensing module can also perform the low resolution image sensing and the high resolution image sensing via other methods. FIG. 5, FIG. 6 and FIG. 7 are schematic diagrams illustrating the examples for how the image sensing module performs a low resolution image sensing and a high resolution image sensing. In the example of FIG. 5, the image sensing module 500 (i.e. the image sensing module 203 in FIG. 2, FIG. 3) comprises an image matrix PM. The image sensing module 500 performs the image sensing via all pixels in the pixel matrix PM if the image sensing module performs the high resolution image sensing, and the image sensing module 500 performs the image sensing via performing pixel binning to the pixel matrix PM if the image sensing module 500 performs the low resolution image sensing. For example, if the pixel matrix comprises pixels P₁₁ , P₁₂, P₁₃, P₁₄, P₂₁, P₂₂, P₂₃, P₂₄, the image sensing module 500 uses the pixels P₁₁, P₁₂, P₁₃, P₁₄, P₂₁, P₂₂, P₂₃, P₂₄ to perform the high resolution image sensing. However, the pixels P₁₁, P₁₂, P₂₁, P₂₂ are binned to a pixel, and the pixels P₁₃, P₁₄, P₂₃, P₂₄ are binned to another pixel, if the image sensing module 500 performs the low resolution. Please note the present invention does not limit to combine four pixels to one pixel, and does not limit the scope to the arrangement in FIG. 5. Binning the pixels via other numbers of pixels or other arrangement to perform the low resolution image sensing should also fall in the scope of the present invention.

In the embodiment of FIG. 6, the image sensing module 600 also comprises a pixel matrix PM. The image sensing module 600 performs the low resolution image sensing via a small region of the pixel matrix Rs (i.e. fewer pixels). On the contrary, the image sensing module 600 performs the high resolution image sensing via a large region RL of the pixel matrix PM (i.e. more pixels). In the embodiment of FIG. 7, the image sensing module 700 also comprises a pixel matrix PM. The image sensing module 700 performs the low resolution image sensing via only part for pixels, which are not adjacent to each other, of the pixel matrix. The image sensing module 700 performs the high resolution image sensing via all pixels of the pixel matrix PM. For example, if the pixel matrix comprises pixels P₁₁, P₁₂, P₁₃, P₁₄, P₂₁, P₂₂, P₂₃, P₂₄. The image sensing module 700 only utilizes pixels P₁₁, P₁₃, P₂₁, P₂₃ if the image sensing module 700 performs the low resolution image sensing. On the contrary, the image sensing module 700 utilizes all pixels P₁₁, P₁₂, P₁₃, P₁₄, P₂₁, P₂₂, P₂₃, P₂₄ if the image sensing module 700 performs the high resolution image sensing. Please note the present invention is not limited to the arrangement shown in FIG. 7, perform the low resolution image sensing via other arrangements should all fall in the scope of the present invention.

Please note the concept of the present invention is not limited to the eye tracking apparatus, it can be applied to other apparatuses, such that the high resolution image sensing and the low resolution image sensing can be applied to different functions. Therefore, one aspect of the present invention can be summarized as follows: An image sensing system comprising: a controller; and an image sensing module. If the image sensing module performs a low resolution image sensing and the controller senses a trigger operation, the controller controls the image sensing module to perform a high resolution image sensing.

According to above-mentioned embodiments, an image sensing method can be acquired, which comprises the following steps: an image sensing method, applied to an image sensing module, comprising the following steps: sensing if a trigger operation exists; controlling the image sensing module to switch from the low resolution image sensing to a high resolution image sensing, if the image sensing module performs a low resolution image sensing and the trigger operation is sensed. Additionally, according to above-mentioned embodiments, an eye tracking method is acquired, which is applied to an eye tracking system comprising a display and an image sensing module, comprising: sensing if a trigger operation exists; controlling the image sensing module to perform a low resolution image sensing to determine if an user watches the display; and controlling the image sensing module to switch from the low resolution image sensing to a high resolution image sensing, to track the user's eye sight, if the image sensing module performs a low resolution image sensing and the trigger operation is sensed. The detail steps for these methods can be acquired according to above-mentioned embodiments, thus are omitted for brevity here.

In view of above-mentioned embodiments, the present invention can perform the low resolution image sensing or the high resolution image sensing corresponding to different functions. By this way, the issue due to performing a constant resolution image sensing can be avoided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image sensing system, comprising:
a controller; and
an image sensing module;
wherein if the image sensing module performs a low resolution image sensing and the controller senses a trigger operation, the controller controls the image sensing module to switch from the low resolution image sensing to a high resolution image sensing.

2. The image sensing system of claim 1, wherein image sensing module further performs the low resolution image sensing via a high light sensitivity, wherein image sensing module further performs the high resolution image sensing via a low light sensitivity.

3. The image sensing system of claim 1, wherein the image sensing module further comprises a high resolution image sensor and a low resolution image sensor, wherein the high resolution image sensor performs the high resolution image sensing image sensor when the image sensing module performs the high resolution image sensing, and the low resolution image sensor performs the low resolution image sensing image sensor when the image sensing module performs the low resolution image sensing.

4. The image sensing system of claim 1, wherein the image sensing module comprises a pixel matrix;
wherein the image sensing module performs the high resolution image sensing via all pixels in the pixel matrix;
wherein the image sensing module performs the low image sensing via performing pixel binning to the pixel matrix.

5. The image sensing system of claim 1, wherein the image sensing module comprises a pixel matrix;
wherein the image sensing module performs the high image sensing via a large region of the pixel matrix;
wherein the image sensing module performs the low image sensing via a small region of the pixel matrix.

6. The image sensing system of claim 1, wherein the image sensing module comprises a pixel matrix;
wherein the image sensing module performs the high image sensing via all pixels of the pixel matrix;
wherein the image sensing module performs the low image sensing via only part for pixels, which are not adjacent to each other, of the pixel matrix.

7. The image sensing system of claim 1, wherein the image sensing module senses environment light via the low resolution image sensing if the controller controls the image sensing module to sense the environment light and to determine intensity of the environment light.

8. The image sensing system of claim 7, wherein the image sensing module senses the environment light via the low resolution image sensing before the controller controls the image sensing module switches from the low resolution image sensing to the high resolution image sensing.

9. An eye tracking system, comprising:
a display;
a controller; and
an image sensing module;
wherein the controller controls the image sensing module to perform a low resolution image sensing to determine if a user watches the display;
wherein the controller controls the image sensing module switches from the low resolution image sensing to a high resolution image sensing to track the user's eye sight if the image sensing module performs the low resolution image sensing and the controller senses a trigger operation.

10. The eye tracking system of claim 9, wherein image sensing module further performs the low image sensing via a high light sensitivity, wherein image sensing module further performs the high image sensing via a low light sensitivity.

11. The eye tracking system of claim 9, wherein the trigger operation comprises at least one of following operation: the user's eye sight stops at a specific point of the display for a predetermined period of time, the user performs a specific gesture, and the user actives a switch.

12. The eye tracking system of claim 9, wherein, if the eye tracking system is to perform a iris identifying or a user authenticating, the controller controls the image sensing module to perform the high resolution image sensing to perform the iris identifying or the user authenticating.

13. The eye tracking system of claim 12, wherein the user gazes at a particular region of the display to perform the iris identifying or the user authenticating.

14. The eye tracking system of claim 9, wherein the image sensing module senses environment light via the low resolution image sensing if the controller controls the image sensing module to sense the environment light and to determine intensity of the environment light.

15. The eye tracking system of claim 14, wherein the image sensing module senses the environment light via the low resolution image sensing before the controller controls the image sensing module switches from the low resolution image sensing to the high resolution image sensing.

16. The eye tracking system of claim 9, wherein controller controls the image sensing module to perform the low image sensing, to determine if the user performs a putting on operation for an accessory apparatus.

17. The eye tracking system of claim 16, wherein the accessory apparatus is applied to assist a tracking for the user's eye sight.

18. An image sensing method, applied to an image sensing module, comprising:
sensing if a trigger operation exists; and
controlling the image sensing module to switch from the low resolution image sensing to a high resolution image sensing, if the image sensing module performs a low resolution image sensing and the trigger operation is sensed.

19. The image sensing method of claim 18, comprising:
controlling the image sensing module to further perform the low resolution image sensing via a high light sensitivity; and
controlling the image sensing module to further perform the high resolution image sensing via a low light sensitivity.

20. The image sensing method of claim 18, comprising:
controlling the sensing module to sense environment light via the low resolution image sensing if the image sensing module is controlled to sense the environment light and to determine intensity of the environment light.
